(19) United States
(12) Patent Application Publication
(10) Pub. No.: US 2005/0233742 A1
(43) Pub. Date: Oct. 20, 2005

(54) Location based directories Via a broadband access gateway

(76) Inventors: Jeyhan Karaoguz, Irvine, CA (US); Marc Abrams, Aliso Viejo, CA (US); Nambirajan Seshadri, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/095,191

(22) Filed: Mar. 30, 2005

Related U.S. Application Data
(60) Provisional application No. 60/563,894, filed on Apr. 16, 2004.

(51) Int. Cl. H04Q 7/20

(52) U.S. Cl. 455/432.3; 455/406

(57) ABSTRACT

A system and method supporting the collection and searching of information about sources of multimedia information and services is disclosed. A broadband access gateway may collect information describing multimedia information and services that may be available for sharing by access devices with which it is in wired or wireless communication. The collected descriptive information may be searched by the broadband access gateway using parameters provided by a user of an access device, to identify multimedia information and services of interest to the user. The results of the search may be distributed to the user that requested the search, and may be used to access the identified multimedia information and services. The gateway may classify the collected descriptive information about the available multimedia information and services, to simplify access by the user. The broadband access gateway may also support the synchronization of multimedia information across two or more access devices.

### RELATED APPLICATIONS

The present application makes reference to, claims priority to, and claims benefit of U.S. Provisional Patent Application Ser. No. 60/563,894, entitled “Method And System For Handling And Backhauling Traffic From A Wired And/Or Wireless WAN, LAN, And/Or PAN Using A Broadband Access Gateway” (Attorney Docket No. 15656US01 BP3607), filed Apr. 16, 2004, the complete subject matter of which is hereby incorporated herein by reference, in its entirety.

The present application makes reference to U.S. patent application Ser. No. 11/021,294, entitled “Method And System For Extended Network Access Services Advertising Via A Broadband Access Gateway” (Attorney Docket No. 15723US02 BU3607.2), filed Dec. 23, 2004, the complete subject matter of which is hereby incorporated herein by reference, in its entirety.

The present application also makes reference to U.S. patent application Ser. No. 11/039,020, entitled “Method And System For Providing Registration, Authentication, And Access Via A Broadband Access Gateway” (Attorney Docket No. 15724US02 BU3607.3), filed Jan. 18, 2005, the complete subject matter of which is hereby incorporated herein by reference, in its entirety.

The present application also makes reference to U.S. patent application Ser. No. ______, entitled “Registering Access Device Multimedia Content Via a Broadband Access Gateway” (Attorney Docket No. 15726US02 BU3607.5), filed ______, the complete subject matter of which is hereby incorporated herein by reference, in its entirety.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

One major common problem faced by cellular and landline service providers is market competition. In today's climate of competitive markets, cellular service providers have found that one way for them to grow market share and defend their businesses is to be proactive and form alliances, and to partner with landline service providers. In addition, cellular service providers seek to differentiate their service offerings, and to capture the largest portion of market revenue by meeting an ever increasing demand for access to a wide range of media forms such as MP3 encoded audio, still and video imaging, data, instant messaging, and email. In a similar manner, the landline service providers have found that to grow market share and ward off competition, they too must be proactive and form alliances, and to partner with cellular service providers. Support for broad economical access to these converging forms of communication is needed to enable unfettered market growth, and to support the development and use of new handheld devices needed to provide increasing levels of mobile multimedia communication functionality.

Although the formation of alliances and partnerships between cellular service providers and landline service providers may help to ward off competition, such alliances and partnerships are faced with other problems. For example, the erection of cellular infrastructure such as cellular towers may be an expensive venture since this may require acquisition of real estate, whether in the form of outright purchases or through leasing. Cellular infrastructure also requires the establishment of one or more expensive backbone links to handle core network traffic. Another cellular-related problem is that the cellular signals do not penetrate and propagate in buildings such as homes and offices very well. This is especially true with the frequencies that are typically utilized in the United States, which may vary between 800 MHz and 1900 MHz or 1.9 GHz.

The use of digital media is growing at an extremely rapid pace. Most consumers today have a variety of devices that gather, store, process, generate, communicate, play back, and/or display information electronically, in a digital form. Examples of such devices include digital still and video cameras, personal digital assistants (PDAs), laptop and desktop personal computer (PC) systems, video cassette recorders (VCRs), personal video recorders (PVRs), document and photo scanners, digital and high definition television sets, stereo audio equipment, and cellular phones, to name only a few. Many times, this multimedia information may be of interest to or available from others. Presently there is no convenient way for a consumer to make such information available, or to identify and access information that may be shared by users of the devices listed above. A consumer wishing to share information, or wishing to locate information that may be of interest may be required to have a knowledge of cabling, software applications, and network operation that is beyond may users. In addition, tools that may be used for searching are typically hit-or-miss, having been designed to search for and process only files having at least some textual content.

Although many consumers may have multiple electronic devices capable of sharing and using similar types of information, sharing is typically an “on-demand” process. That is, in general, sharing of information among electronic devices is initiated by a user. Although it may be advantageous to have information automatically updated, such automatic sharing is not normally supported among electronic devices, but requires that an opportunity for sharing be recognized by a consumer, and that arrangements be made for such sharing between devices.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and method for supporting searching of information describing at least one of multimedia information and media-related services residing within a plurality of access devices, substantially as shown in and/or described in connection with at least one of the figures, as set forth more completely in the claims.

These and other advantages, aspects, and novel features of the present invention, as well as details of illustrated embodiments, thereof, will be more fully understood from the following description and drawings.

### BRIEF DESCRIPTION OF SEVERAL VIEWS OF THE DRAWINGS

FIG. 1 is a block diagram illustrating an architecture of an exemplary communications system in which a representative embodiment of the present invention may be practiced.

FIG. 2 shows a block diagram illustrating an exemplary communication system, in accordance with a representative embodiment of the present invention.

FIG. 3 shows an illustration of an exemplary gateway that supports the searching of a database that lists available multimedia information and services, in accordance with a representative embodiment of the present invention.

FIG. 4 illustrates an exemplary display of an access device that may, for example, correspond to the display of the access device, the laptop, and the wireless PDA of FIG. 2, showing a pop-up advertisement, in accordance with a representative embodiment of the present invention.

FIG. 5 illustrates an exemplary display of an access device that may, for example, correspond to the display of the access device, the laptop, and the wireless PDA of FIG. 2, in accordance with a representative embodiment of the present invention.

FIG. 6 illustrates an exemplary search parameters screen that may be used to provide search parameters to a search engine of a broadband access gateway in accordance with a representative embodiment of the present invention.

FIG. 7 illustrates an exemplary display showing a listing of the results of a search using the search engine functionality provided via the search engine icon of FIG. 5, using the search parameters shown in FIG. 6, in accordance with a representative embodiment of the present invention.

FIG. 8 is a flowchart for an exemplary method of supporting access to multimedia information and media-related services via a broadband access gateway such as, for example, the gateway of FIGS. 2 and 3, using a location-based database and search engine, in accordance with a representative embodiment of the present invention.

FIG. 9 is a flowchart for an exemplary method of supporting synchronization of multimedia information via a broadband access gateway such as, for example, the gateway of FIGS. 2 and 3, using a location-based database and search engine, in accordance with a representative embodiment of the present invention.

### DETAILED DESCRIPTION OF THE INVENTION

Aspects of the present invention relate to the seamless merging of wide area networks, from any kind of wired and/or wireless wide area networks, to pockets of wired and/or wireless local area networks and personal area networks, which may be located in homes or other environment such as an office or business. More specifically, aspects of the present invention pertain to a broadband access gateway supporting search and synchronization functionality permitting users of access devices to identify, be made aware of, and to access multimedia information and services. Such a gateway may permit broadband network access via, for example, a personal cellular microcell, a personal area network (PAN), a wired or wireless wide area network (WAN), wireless local area network (WLAN) or other type of network located within a premises such as, for example, a home, office, business, or the like. Services that may be available via such a broadband gateway connection include, for example, access to the public switched telephone network (PSTN); Internet protocol (IP) phone access; extended access to commercial cellular and PCS networks such as, for example, TDMA, CDMA, and GSM; and access to and/or control of a variety of multimedia access devices or networked resources capable of providing streams of images, still pictures, video, and audio; to name only a few. Examples of multimedia information include streaming video, broadcast video, voice, digital data, text, digitized audio, digitized still images, digitized video, and digitized music. The merging of these various types of networks may enable transparent communication of all types of media between access devices, which may be coupled in a wired or wireless fashion to one or more of these networks. In an embodiment of the present invention, access to services available through a wireless broadband gateway may be simplified, permitting their use by a wider group of users of access devices in, for example, homes, offices, and businesses.

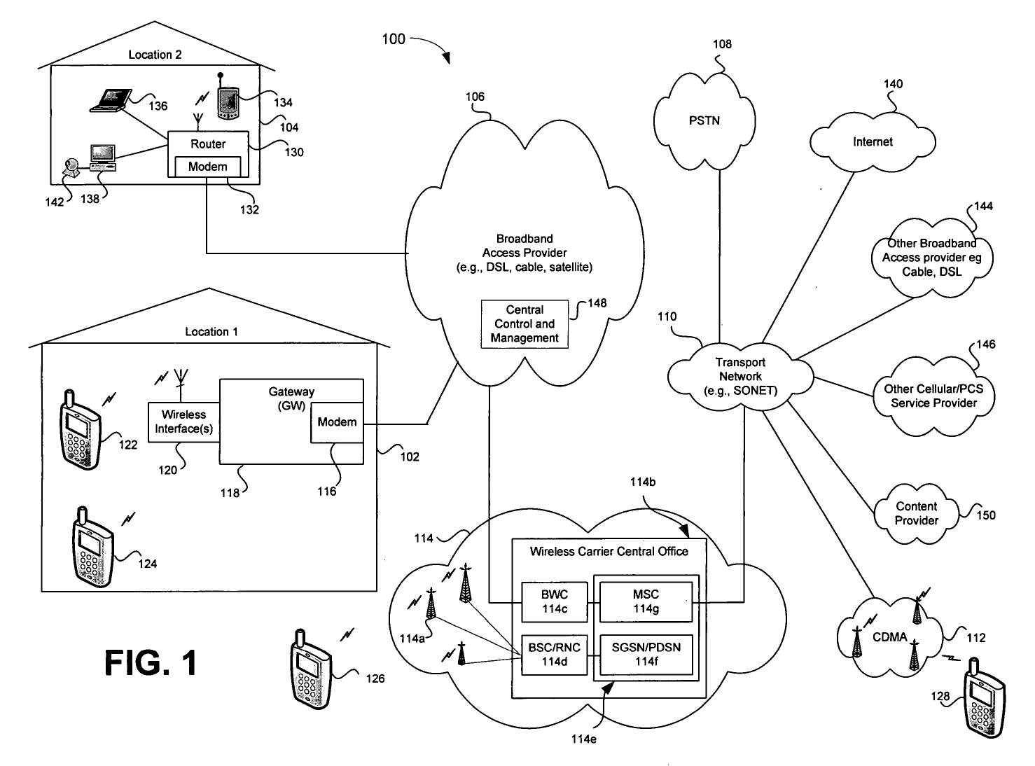

FIG. 1 is a block diagram illustrating an architecture of an exemplary communications system in which a representative embodiment of the present invention may be practiced. Referring to FIG. 1, there is shown a first location 102, a second location 104, a broadband access provider (BAP) 106, public switched telephone network (PSTN) 108, a transport network 110, wireless networks including CDMA network 112 and GSM network 114, and access devices 126 and 128. The first location 102 comprises a gateway 118 having a modem 116, a wireless interface(s) block 120, and the access devices 122, 124. The access devices 122, 124, 126, 128 may comprise, for example, a mobile multimedia handset having a high level of functionality such as, for example, that of one or more of a digital video or still camera, a portable audio (MP3) player, a personal digital assistant, and a voice handset. The access devices 122, 124, 126, 128 may be capable of operating using, for example, a personal area network and/or wireless local area network compliant with, for example, Bluetooth, IEEE 802.11 a/b/g/n, and/or IEEE 802.15.3a ultra-wideband standards. The second location 104 comprises a router 130 having a modem 132, and a plurality of wireless access devices. The plurality of wireless access devices at the second location 104 may comprise a personal computer (PC) 138, a laptop 136 and a wireless personal digital assistant (PDA) 134. A peripheral such as a digital camera 142 may be coupled to the personal computer 138. Other peripherals such as printers, digital scanners, speakers, and the like, which are not shown, may also be coupled to the personal computer 138 and/or laptop 136. The wireless interface block 120 may comprise a plurality of interfaces such as a Bluetooth interface, an IEEE 802.15.3a ultra-wideband interface, and any combination of an IEEE 802.11 a, b, g and/or n interface.

FIG. 1 also comprises an “other broadband access provider” block 144, an “other cellular/PCS service provider” block 146, a central control and management block 148, and content provider 150. The “other broadband access provider block 144” may be, for example, a cable, DSL, or other type of broadband access provider. The central control and management block 148 may comprise suitable logic, circuitry and/or code that may be adapted to handle content delivery and security functions such as authentication, validation, key or certificate management, and authorization. The central control and management block 148 may also be adapted to handle provisioning and service management. In a representative embodiment of the present invention, the central control and management block 148 may establish communications links with, for example, the gateway 118, the broadband access provider 106, the other broadband access provider 144, the other cellular/PCS service provider 146, the CDMA network 112, and the GSM network 114 using actual or virtual connections.

The broadband access provider 106 may be, for example, a cable operator, telephone company, or satellite operator providing Internet access along with other communication services. In instances where BAP 106 is a telephone company, broadband service to locations 102, 104 may be provided via DSL or other broadband access technology. Accordingly, the modems 116, 132 may be DSL modems. In instances where BAP 106 is a cable operator, broadband service to locations 102, 104 may be provided via cable. Accordingly, the modems 116, 132 may be DOCSIS compliant or other type of cable modem. Given the rapid decrease in the cost of leased telephone lines over the past decade or more, the connection to the location 102, 104 may also be T1 or T3 connections. For example, a switch located at a central office (CO) (not shown) may be utilized to couple a T1 or T3 connection between the second location 104 and the PSTN 108.

The gateway 118 may comprise an integrated DSL modem, cable modem or other high-speed modem that may be required for handling a connection such as a T1 or T3 connection. Alternatively, the gateway 118 may be coupled to an external DSL modem, cable modem or other high-speed modem that may be capable of handling connections such as a T1 or a T3 connection. The gateway 118 may be adapted so that it has access to protocol stack information that may be related to the GSM and/or CDMA networks 114, 112, respectively. The gateway 118 may also be adapted to provide protocol support for communication with “other cellular/PCS service provider” block 146.

Each of the CDMA and GSM networks 112, 114 may comprise a plurality of cell sites (a/k/a cellular towers) that are located in geographical cells within each of the networks. Within the GSM network 114, each of the cell sites such as, for example, cell site 114a may comprise a base transceiver station (BTS), and one or more base transceiver stations (BTSs) may be coupled to wireless carrier central office 114b. The wireless carrier central office 114b may comprise a base station controller/radio network controller (BSC/RNC) such as BSC/RNC 114d. One or more base station controllers/radio network controllers (BSCs/RNCs) may be coupled to the core network 114e, that comprises a network edge switch called a mobile switching center (MSC), such as MSC 114g, and a serving GPRS support node (SGSN)/packet data serving node (PDSN) 114f, of the GSM network 114. The mobile switching center may be coupled to, for example, the PSTN 108 via the transport network 110. As an access device moves out of range of a first cell site to within range of a second cell site, the decrease signal power received from the first cell site and the increase in signal power received from the second cell site causes initiation of handoff of a call from the first cell site to the second cell site. In cases where there is no second cell site to handoff to, the call may be maintained by the first cell site power until it is attenuated to a threshold where it is no longer feasible to maintain the call. At the point where the power reaches or falls below this threshold, the call may drop and any related call resources may be relinquished. In a home and/or office environment, it may be desirable to have a second network to which the call may be handed off to.

As an illustration, a user may be on their way home and as the user approaches their home, the signal may fall below a minimum signal power threshold that is required to maintain a call. However, instead of dropping the call, the call may be handed off to, for example, a PAN or a wireless local area network (WLAN) that may be located within the user's home or an unlicensed wireless access system that may be located in the user's home. For example, with reference to FIG. 1, as access device 126 migrates from the vicinity of the serving cell site 114a in GSM network 114 towards the wireless interface 120 in the first location 102, the call may be handed off from the cell site 114a GSM network 114 to the wireless interface 120 coupled to the gateway (GW) 118 at the first location 102. Accordingly, instead of the call being dropped, the call has been seamlessly handed off and is now being handled by the gateway 118 via the wireless interface 120. The resulting wireless data may then be communicated to the GSM network 114 via the broadband connection to the BAP 106 which is connected to the broadband wireless local area network controller (BWC) 114c.

In this illustration, the user is handed off to their PAN, WLAN, or other network located within their home. However, the user could also have been handed off to another network system such as a neighbor's network. In any case, a gateway coupled to the wireless interface which is providing service to the user may communicate at least a portion of the data to, for example, the cable or DSL BAP 106, the GSM network 114, CDMA network 112, other broadband access service provider 144, other cellular/PCS service provider 146 and central control and management block 148. The user may be provided with a notification that indicates the presence of the PAN, WLAN, or other unlicensed network. For example, an icon representative of a personal area network may be displayed on the screen of the access device 126 once a soft or hard handoff is achieved from a serving cell site in GSM network 114 to the wireless interface 120 at the first location 102. A special tone or other audio alert may also be utilized to indicate that the call has switched to the wireless interface 120.

In instances where the gateway 118 detects a compatible access device that may be within the range of the wireless interface 120, the gateway 118 may immediately advertise its available services to the access device. In this regard, the gateway 118 may be adapted to transmit service advertisements to the access device in order to alert a user of the access device of the types of services that are being offered by the gateway 118. Signals containing icons representative of the services may be transmitted to and displayed on a screen of the access device and/or audio alerts may be utilized to notify the user of these services.

In another embodiment of the invention, quality of service (QoS) may also be advertised by the gateway 118. For example, when a user is being serviced by the wireless interface 120, the gateway 118 may advertise that stereo audio is available.

Access devices may be pre-registered so that when they are within the range of the wireless interface 120, the gateway 118 may automatically recognize them. For the pre-registration, an administrator of the gateway 118 at the first location 102 may register access devices that are allowed to access the gateway 118 when they are within the range of the wireless interface 120. Pre-registration may be done prior to the access device accessing the gateway 118. During pre-registration, an administrator or owner of the gateway 118 may enter registration or configuration information such as device IDs of access devices belonging to friends and/or family member's into a registration database associated with the gateway 118. As a result, these devices will be allowed to access at least a portion of the services offered by the gateway 118 whenever they attempt to access the gateway 118 by pressing a single button, for example. Opportunistic registration permits a user of an access device to register with the gateway 118 automatically with little or no effort on the part of the user. In this regard, registration information may be sent to the gateway 118 from an access device during an initial access and the gateway 118 may chose to accept or deny the registration. The registration information may be automatically or manually sent to the gateway 118.

In certain instances, an access device may not have been pre-registered to access the network. In this case, one button access may be provided. A single button such as a hard coded button or software-enabled button on an access device may be programmed to transmit identifying information from the access device to the gateway 118. The gateway 118 may utilize this transmitted identifying information to grant or deny access to its services. For example, one button may be programmed to contain access device identifying information related to accessing the services provided by gateway 118 at the first location 102. The gateway 118 may also be adapted to utilize digital certificates to authenticate access devices.

An interactive process may also be provided, whereby the gateway 118 may prompt or request particular information, for example a password from an access device requiring network access. If the particular information is received, then access to at least some of the services provided by the gateway 118 may be granted and if not, the access to at least some of the gateway's services may be denied.

In another embodiment of the invention, the one button access may be provided via software-enabled button (soft button) or hardware-enabled button (hard button). In this regard, the software button may be displayed on a screen of an access device.

A “walled garden” approach may be utilized to provide access to the services that may be offered by a particular gateway, for example, gateway 118. Under the walled garden approach, when an access device first registers or is identified, a basic set of services may be provided by the serving gateway 118 to the access device 124. The basic services offered may vary among each gateway. At least some of the basic services that are provided by a gateway such as gateway 118, may be offered without authenticating the access device 124. However, other services may only be offered if an access device such as access device 124 is properly authenticated. These services that are offered may be services that were advertised by the gateway 118.

In an aspect of the invention, access to additional services may be granted based on, for example, user identity, access device identity and or user input. The services offered to an access device by a gateway may be arranged in a hierarchical structure such as a tier. For example, in a first tier, a user may be prompted to enter membership information such as a member identification number. Upon authentication of the membership identification number, the first tier may provide restricted access with pop-up advertisements that may not be disabled. In a second tier, for example, a user may be prompted to enter a password. Upon authentication of the password, second tier information may provide restricted access to gateway services without pop-up advertisements. In a third tier, for example, entering billing information such as an account number or credit card or check card number may provide unlimited and/or unrestricted access to all the services offered by a gateway. A fourth tier may provide only operating instruction and information for guests.

An administrator of the gateway may establish the type of access provided by the walled garden. For example, if the first location 102 is a hotspot at a Café, the provider of the gateway may establish the service access levels or tiers that may be provided by the gateway 118.

When an access device is within the range of the gateway 118, wireless service is handed off from a serving cell site 114a in the GSM network 114 to the gateway 118. The access device may be authenticated by the gateway 118 and permitted to access at least some of the services offered by the gateway 118. Once the access device is authenticated, at least a portion of the information on the access device may be made available as a networked resource via the gateway 118. A user of the access device may chose whether information on the access device may be made available to the gateway and if so, that information which will be made available, and that information which will be unavailable to the gateway 118. In this regard, where information is made available, the gateway 118 may maintain a list of the resources that may be available on access devices that may be coupled to the gateway 118. For example, a list of contact information, calendar information, audio files, video file and/or data files stored on the access device may be sent to the gateway 118.

The resources that are available on the access device may also be advertised to other access devices that may be in communication with the gateway 118. Advertisement of the resources that may be available on an access device may be restricted to, for example, a list of particular devices, a particular type of devices or to a particular user. Accordingly, a user may have to be properly authenticated prior to certain information being made available to the user. Additionally, advertisement of the resources may cause certain icons representative of the resources to be displayed on other access devices. In a similar manner, icons representative of the resources that may be available on these other access devices may also be presented on the access device.

An access device may be provided with a welcoming screen that may allow a user of a device to sign up for either free or paid services. Once the signup is complete, subsequent access by the user may be authenticated by the gateway 118 utilizing the signup information. Whenever an access device registers with and/or is authenticated by the gateway 118, information on the access device may be updated and/or synchronized with information that may be on the gateway 118.

Devices within the location of the gateway 118 may be configured to register certain portions of their data content with the gateway 118 through a gateway registration process. Once data for these devices is registered to the gateway 118, the gateway may maintain a database, which keeps track of the data that is available, and its location. Accordingly, if the data previously stored in the database is no longer available, then information representative of the previously stored data may be removed from the database. Data from devices coupled to the gateway 118 such as on laptops, CD players, digital video disk (DVD) players, TIVO, personal video recorders (PVRs), personal digital assistants (PDAs) and other devices, may be registered with the gateway 118. This data may comprise audio, video, still pictures, and/or text.

At least a portion of the registered data may be made available to other network access devices via the gateway 118. In an aspect of the invention, the gateway 118 may be adapted to maintain a searchable list of data that may be available via the gateway. In this regard, the gateway may comprise a search engine that may be utilized to locate and distribute data that may be made available through the gateway 118. In another aspect of the invention, data may be made available to access devices via advertising by the gateway 118. Access devices may be configured to seek out particular data that may be of interest. Accordingly, an access device may be adapted to receive and process only those gateway advertisements may fit particular criteria. Those advertisements that may not fit the particular criteria may be discarded or ignored.

When an access device is within the range of the gateway 118, wireless service may be handed off from a serving cell site 114a in the GSM network 114 to the gateway 118. The access device may be authenticated by the gateway 118 and permitted to access at least some of the services offered by the gateway 118. Once the access device is authenticated, a user of the access device may have a desire to locate a particular video presentation. The user may access the search engine, which may have been advertised to the user's access device by the gateway 118. The search engine may appear on the display of the user's access device as an icon. The user may then activate a search by selecting the search engine icon, inputting a name of the video presentation and executing the search.

In another embodiment of the invention, the gateway may be adapted to classify information based on a given criterion. This classification may assist with locating information based on a particular criterion. In this regard, a user of the access device may be presented with a list of classifications and may select one, which may be of interest based on a particular criterion. This may narrow the focus of a search.

The gateway may also be utilized to facilitate seamless synchronization of data between devices that may be wired or wirelessly coupled to the gateway 118. For example, audio files located in a music folder on a PC coupled to the gateway 118 may be synchronized with a wireless media player coupled to a hot spot in an airport while a user of the wireless access media player waits to board a flight. In this regard, the gateway may determine what files need to be synchronized and control how the synchronization is accomplished. The same is true for files that may be downloaded from the PC to the wireless access media player, and for files that may be uploaded from the wireless access media player to the PC. Calendar and/or contact information may also be updated and/or synchronized with a mobile multimedia handset in a similar manner utilizing the gateway 118.

A location-aware service determines an approximate location of a network device and adapts delivery of a particular service application and/or content according to a quality of service criterion. The delivery of location-aware services may be controlled by the gateway 118. For example, a user of an access device may request playback of an audio clip via the gateway 118. After receiving the request for playback of the audio clip, the gateway 118 may determine that a channel between the gateway 118 and the user's access device may only be capable of maintaining a reduced playback rate. As a result, instead of sending 128 kbps encoded audio data, then the gateway may send 96 kbps data. Hence, in a case where the audio data was originally stored in 128 kbps sampled audio data, then the gateway 118 may transcode the 128 kbps sampled data to 96 kbps audio data.

In another illustrative embodiment of the invention, while the GSM network 114 is servicing the access device, lower compression rates may be utilized to provide service to the access device. However, when the access device roams within range of the wireless interface 120 and is being served by the gateway 118 through wireless interface 120, higher compression rates may be utilized. For example, audio data sampled at a data rate of 64 kbps may be utilized for playback on an MP3 enabled telephone while the phone is being serviced by a cell site 114a in the GSM network 114. However, once the MP3 enabled telephone is within the operating range of the wireless interface 120 and is being serviced by the gateway 118, the gateway 118 may automatically adapt to a higher data rate of, for example, 92 kbps or 128 kbps.

Automatic format conversion by the gateway 118 may include converting data from a first format to at least a second format suitable for delivery and/or display on an access device. This may permit data that would otherwise be incompatible with a first access device to be played on that first access device. For the location-aware services based on QoS, data was converted from a first format 128 kbps to a second format 96 kbps to achieve and/or maintain a particular QoS, but the data type remained the same. In this case, the audio format and/or its data type may be different. For example, if the audio format was MP3, then after the conversion, the format remained WAV and/or the sampling rate may have decreased from 128 kbps top 96 kbps.

In conventional wired caller ID systems, a name and/or directory number (DN) of a calling party may be transferred either in-band or out-of-band to a called party and may be displayed on the called party's caller ID display when a call is answered. In these conventional systems, the caller ID information is limited to a callers name, directory number (DN), general location and/or time of call. In wireless telephone systems, in order to save on bandwidth, only a caller's directory number is transferred and displayed to a calling party. However, if the calling party's directory number and name is stored in the called party's phone, then the stored name and stored directory number will be presented on a display of the called party's terminal. In this case, the stored directory number is compared with the transferred caller's directory number, and if a match occurs, then a name corresponding to the matching directory number is also displayed on the called party's terminal.

In accordance with an embodiment of the invention, the gateway 118 is adapted to determine the appropriate caller ID information that may be displayed in a called and/or calling party's caller ID. In this case, reverse caller ID information may be displayed on both a calling and a called parties terminal by the gateway 118.

If a called and/or calling device is a mobile multimedia handset and/or laptop, for example, contact or other personal information may be displayed the caller's and/or calling party's directory number. The level or amount of information that may be displayed may be varied. Certain sensitive information relating to either the called or calling party may be restricted from being displayed.

In current cellular communication systems, over the air (OTA) programming is utilized to program a cellular telephone during the provisioning process. In some instances, cellular providers have established websites that may be utilized or OTA programming. In this regard, a cellular subscriber may access the website and enter information such as the assigned directory number and the electronic serial number of the cellular telephone being programmed.

In accordance with a representative embodiment of the invention, an access device may be registered using over the air programming via the gateway 118. A user of an access device may send access device information to the gateway 118 using, for example, a default interface that may be presented to and displayed on a screen of the access device when the access device first enters the service area of the wireless interface 120. During registration, the capabilities of an access devices may be sent to the gateway 118 and may be shared with devices that may be coupled to the gateway 118.

Since the gateway acts as a registrar of information for all the access devices that may be wired or wirelessly coupled to it, the gateway may function as a personal digital assistant for any of these access devices. In an illustrative example, a first device, a first PC and a second PC are being serviced by the gateway 118. The first access device receives a call and the caller ID information shows the callers name, home directory number and home address. However, the first PC contains the business address for the caller and the second PC contains the monthly calendar information for the caller. Assume that the caller had a desire to setup a business meeting. In accordance with an aspect of the invention, the gateway 118 may be adapted to provide the business address of the caller to the first access device and also provide the caller's calendar to the first access device. In this manner, the network centrally provides all the information necessary for scheduling the meeting. In this example, the first PC may belong to the user of the first access device and the second PC may belong to the caller.

This concept may be extended to a look-up or 411 directory assistance on the Internet. The lookup may also be location dependent. In this regard, if a user is located in Hollywood and requests a hotel location, the gateway 118 may only cause the hotels that are located in Hollywood to be displayed to the user.

The gateway 118 may also be adapted to create profile information based on data usage. These created profiles may be utilized to create social networks for people having common interests. Accordingly, users may be permitted to post their interests and also select those people having similar interests based on the created profile. Based on the created profile information and the posted user interests, the gateway 118 may also generate a list of those people who have similar interest and also those users that may potentially have similar interests.

Given the capability to seamlessly operate an access device as one migrates from outside the home into the home, it is desirable to have a single device that may be adapted to control at least some of the devices that may be found within the home. In addition to its normal voice or data communication operating mode, an access device may be configured to operate as a universal remote that may be utilized to remotely control a plurality or other devices such as a TV, DVD, CD, Stereo, display monitor, or a combination thereof. Most access devices currently have an IR transmitter, which may be adapted to communicate with other IR receiver devices.

The access device may be used for wireless communication and for remotely controlling an electronic device with as a TV, CD/DVD recorder/player, or other device. The access device may also include at least one soft-button that may be enabled through the gateway 118 and may be utilized to control any other device that may be coupled to the gateway 118.

The gateway 118 is adapted to virtually aggregate data that may be visible from a plurality of access devices or other network devices. Although the gateway 118 may be adapted to store some service and content related information, the gateway 118 does not actually store copies of data that resides the access devices and/or other network devices that may be wired or wirelessly coupled to it. However, the gateway 118 may store, for example, metadata information that may be utilized to locate and access the information stored on the access devices and/or other network devices. The gateway is therefore adapted to function as a registrar of both service and content related information.

Whenever an access device registers with and/or is authenticated by the gateway 118, information may be collected from the access device and related metadata information may be updated and/or synchronized with information that may be currently stored on the gateway 118. Additionally, when a device is no longer being serviced by the gateway 118, associated information may be released from the gateway 118. In this regard, the virtual aggregations function performed by the gateway 118 guarantees that the most current information is accessible from the access devices.

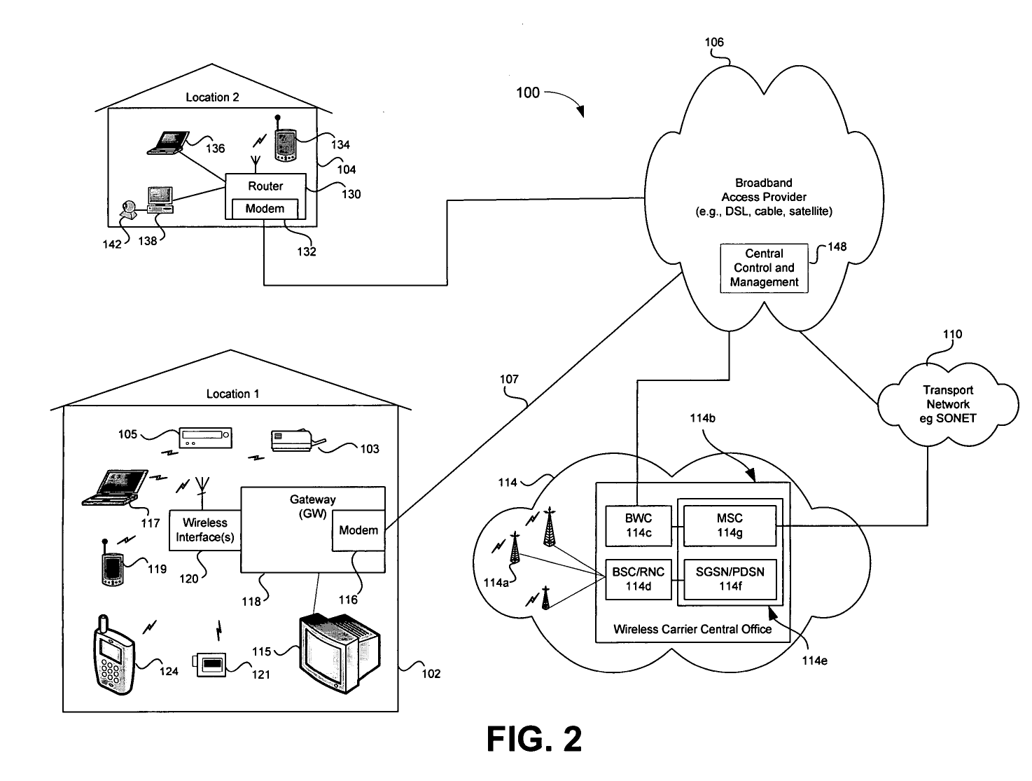

FIG. 2 shows a block diagram illustrating an exemplary communication system 100, in accordance with a representative embodiment of the present invention. The communication system 100 shown in FIG. 2 comprises a wireless interface 120, a gateway (GW) 118 with a modem 116, and an array of access devices such as, for example, a printer 103, a stereo receiver 105, a laptop 117, a wireless personal digital assistant (PDA) 119, and a digital video camera 121, at location 102. The communication system 100 of FIG. 2 also comprises an access device 124 that may correspond, for example, to the access devices 122, 124, 126 of FIG. 1. A second location 104 within communication system 100 comprises a router 130 with a modem 132, and a plurality of wireless access devices. The plurality of access devices at the second location 104 may, for example, comprise a personal computer (PC) 138, a laptop 136, and a wireless personal digital assistant (PDA) 134. A peripheral such as, for example, a digital camera 142 may be coupled to the personal computer 138. Other peripherals such as, for example, printers, digital scanners, speakers, and the like, that are not shown in FIG. 2, may also be coupled to the personal computer 138 and/or laptop 136. The wireless interface 120 may comprise a plurality of interfaces such as, for example, a Bluetooth interface, a cellular interface, and any combination of an IEEE 802.11 a, b, g, and/or n interface, and/or an IEEE 802.15.3a ultra-wideband interface. Although the following discussion refers frequently to the capabilities and actions of the gateway 118 and wireless interface 120, the same may be said of the router 130 with the modem 132 of FIGS. 1 and 2, for example, without departing from the spirit and scope of the present invention.

In accordance with a representative embodiment of the present invention, a wireless access device such as access device 124 may be mobile, and may move between the personal area network/wireless area network coverage provided by wireless interface 120 at location 102, the wide area network coverage provided by, for example, GSM network 114, and the coverage provided by the router 130 and modem 132 at location 104. The location 102 may, for example, be the home of the user of the access device 124, the home of a friend or relative of the user of access device 124, or an office, business, etc., where the user of access device 124 may travel. The location 104 may, for example, be a second home of the user of access device 124, the home of a friend or relative, an office, or may have no personal or business relationship with the user of access device 124. In a representative embodiment of the present invention, the gateway 118 may comprise, for example, a set top box that may be coupled in a wireless or wired fashion to access devices such as, for example, a laptop computer or television, such as the laptop 117 and the television 115 of FIG. 2. Access to the communication bandwidth of a broadband network as previously described may be provided by the gateway 118 and the modem 116 to wired or wireless access devices in the vicinity of location 102, and via router 130 and modem 132 to wired or wireless access devices in the vicinity of location 104, as shown in FIG. 2. This architecture may provide extended access to wireless networks such as, for example, the GSM network 114, CDMA network 112, other cellular/PCS service provider 146, Internet 140 and public switched telephone network 108, of FIG. 1. The modem 116 is shown connected to a broadband access provider (BAP) 106 via a broadband connection 107. The broadband connection 107 may comprise, for example, a digital subscriber line (DSL) connection, a cable network connection, a satellite connection, a T1 or T3 network connection, or similar broadband communication link. The modem 116 is compatible with the broadband connection 107, and may be, for example, a DSL modem, a DOCSIS-compliant cable modem, a satellite service modem, or T1 or T3 compatible modem-type device. The broadband connection may provide access through BAP 106 to location 104, and via transport network 110 to, for example, GSM network 114.

In the example illustration of FIG. 2, a user of the access device 124 may or may not be engaged in communication with another system or subscriber accessible via the GSM network 114, or other wide area network of FIG. 1. Although the present example of FIG. 2 shows a GSM network 114, a representative embodiment of the present invention may be employed with respect to other wide area networks such as, for example, the CDMA network 112 and other cellular/PCS service provider 146, shown in FIG. 1.

When an access device such as, for example, the access device 124 of FIG. 2 moves into the coverage area of a personal area network of, for example, the wireless interface 120 and gateway 118, or the router 130, the access device 124 may be authenticated by the gateway 118 or router 130. The authentication may involve the sharing or exchange of identification and/or authentication information by the access device 124 with the gateway 118 or router 130. Details of an example of such an interaction are provided in U.S. patent application Ser. No. 11/039,020, entitled “Method And System For Providing Registration, Authentication, And Access Via A Broadband Access Gateway” (Attorney Docket No. 15724US02 BU3607.3), filed Jan. 18, 2005, the complete subject matter of which is hereby incorporated herein by reference, in its entirety. Once the access device 124 has been authenticated to the gateway 118, the access device 124 may be permitted to exchange multimedia information and services available via the access devices in communication with the gateway 118, or via networks connected to the gateway 118. Information about the available multimedia information and services may be shared by and/or with the access device 124 via information exchanged by the access device 124 and the gateway 118 or router 130. Additional information about the advertising of such information may be found in U.S. patent application Ser. No. 11/021,294, entitled “Method And System For Extended Network Access Services Advertising Via A Broadband Access Gateway” (Attorney Docket No. 15723US02 BU3607.2), filed Dec. 23, 2004, the complete subject matter of which is hereby incorporated herein by reference, in its entirety.

In a representative embodiment of the present invention, access devices such as, for example, the access device 124, the stereo 105, and the laptop PC 107 within the coverage area of a broadband access gateway such as, for example, the gateway 118 may be configured to register or share certain portions of their data such as, for example, available multimedia information, with the gateway 118 through a gateway registration process. Additional details of such a process are described in U.S. patent application Ser. No. ______ entitled “Registering Access Device Multimedia Content Via a Broadband Access Gateway” (Attorney Docket No. 15726US02 BU3607.5), filed ______, the complete subject matter of which is hereby incorporated herein by reference, in its entirety. Once such information for these access devices is registered or shared with the gateway 118, the gateway may maintain a collection or database, that tracks multimedia information that is available including, for example, its location among the access devices in communication with the gateway 118, and via the broadband network connected to the gateway 118. Accordingly, if the data (e.g., multimedia information) is no longer available, then the previously registered information describing the (no longer available) data may be removed or purged from the database. Multimedia information from a variety of access devices coupled to the gateway 118 such as, for example, data on laptop personal computers (PCs), CD players, digital video disk (DVD) players, TIVO, personal video recorders (PVRs), personal digital assistants (PDAs) and other devices, may be registered with the gateway 118. This multimedia information may, for example, comprise digitized representations of audio, video, images, still pictures, and/or text.

In a representative embodiment in accordance with the present invention, at least a portion of the multimedia information registered by an access device may be made available to other access devices via the gateway 118. In a representative embodiment of the present invention, a broadband access gateway such as, for example, the gateway 118 or router 130 of FIG. 2 may be adapted to maintain a searchable list or database identifying the multimedia information that may be available via the gateway 118. In this regard, the gateway 118 may comprise a search engine that may be utilized to locate and distribute data that may be made available through the gateway 118. For example, the search engine may be used to automatically identify sources of multimedia information in the searchable list or database according to user defined criteria.

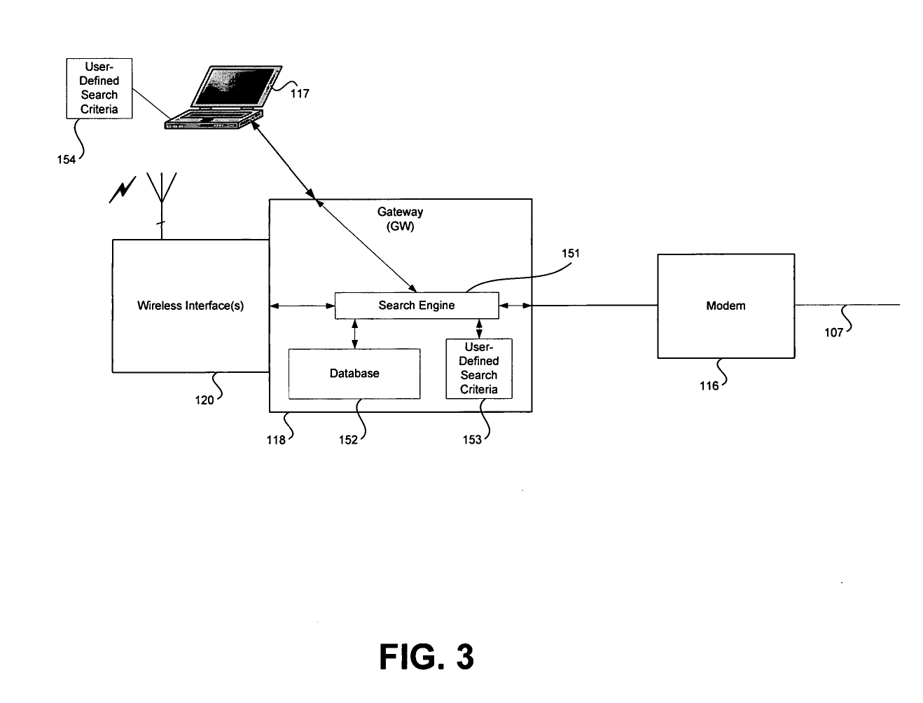

FIG. 3 shows an illustration of an exemplary gateway 118 that supports the searching of a database 152 that lists available multimedia information and services, in accordance with a representative embodiment of the present invention. In the illustration of FIG. 3, the gateway 118 is communicatively coupled to a wireless interface 120, a laptop 117, and a modem 116. The wireless interface 120, the laptop 117, and the modem 116 of FIG. 3 may correspond, for example, to the wireless interface 120, the laptop 117, and the modem 116 of FIG. 2, respectively. The gateway 118 of FIG. 3 also comprises a search engine 151, and a database 152. In one representative embodiment of the present invention, the search engine 151 in a broadband access gateway such as, for example, gateway 118, may be configured in accordance with user-defined search criteria. The user may initiate a search of the database 152 from, for example, an access device such as the access device 124 of FIG. 2, the laptop 117, or the wireless PDA 119 of FIG. 2. The gateway 118 may then, for example, transmit the results of the search activity via wireless interface 120 to the access device 124, for selection of a listed item by the user. In one representative embodiment in accordance with the present invention, the user-defined search criteria may be stored within the access device such as, for example, the user-defined search criteria 154 of laptop 117, and may be communicated to the gateway 118 when the access device is in communication with the gateway 118. In another representative embodiment of the present invention, the user-defined search criteria may be stored in the gateway 118 and associated with the user such as, for example, in the case of user-defined search criteria 153 located within the gateway 118. Later, when the access device of the user comes into communication with and transfers identification information to the gateway 118, the gateway 118 may retrieve and employ the search criteria associated with the user of the access device. The identification information may comprise, for example, access device identifiers, network addresses, media access control (MAC) addresses, electronic serial numbers, personal identification numbers (PINs) of users, and digital certificates.

In a representative embodiment in accordance with the present invention, the gateway may periodically conduct searches of the collection (e.g., database 152 of FIG. 3) that lists available multimedia information, to be able to keep the users of access devices informed of the latest data available for their access. In such an embodiment, the results of the search may be transmitted to the access device of the user as soon as the availability of new multimedia information meeting the search criteria of the user are available. This notification may, for example, take the form of a recognizable icon, a pop-up graphic, or a text message.

In one representative embodiment of the present invention, the search may be limited to the listing of multimedia information present on access devices having direct communication with a broadband access gateway such as, for example, the access device 124, the laptop 117, the wireless PDA 119, the stereo 105, and the printer 103 with the gateway 118 of FIG. 2, or the PC 138, the laptop 136, and the wireless PDA 134, with the router 130 of FIG. 2. In another representative embodiment of the present invention, a search engine such as, for example, the search engine 151 of FIG. 3 may also be capable of perusing multimedia resources accessible via a broadband network connection of the gateway such as, for example, any multimedia resources accessible via broadband connection 107 and BAP 106 of FIG. 2.

In a representative embodiment in accordance with the present invention, an access device such as, for example, the laptop 117 of FIGS. 2 and 3 may contain multimedia information received via, for example, the broadband connection 107. Such multimedia information may be received from providers or sources using a communication protocol or format that may not be supported by other access devices. Once received by the laptop 117, such information may be registered with the gateway 118 and may, therefore, be made available to other access devices within the coverage area of the gateway 118.

In a representative embodiment of the present invention, it may be a function of one or more access devices such as, for example, the laptop 117 to perform searches of sources of data (e.g., multimedia information) not directly discoverable or accessible to the gateway 118, or to other access devices in communication with the gateway 118. For instance, an access device such as, for example, the laptop 117 or wireless PDA 134 may be capable of retrieving stock market or downloadable music information files that the gateway 118, the router 130, or an access device such as the access device 124 may not be equipped or authorized to access. However, once present on an access device in communication with the gateway 118 or the router 130, the data may be registered, and its availability made known to other access devices such as, for example, the access device 124. Continued control over and security of accesses to the stock market or music information files may be provided by the control and security mechanisms established between the access device and the gateway 118, as described above.

In a representative embodiment of the present invention, the results of search engine activity in a broadband access gateway such as, for example, gateway 118 of FIG. 3 may be used to create advertisements for distribution to the users of access devices such as, for example, the access device 124, the laptop 117, or the wireless PDA 119 of FIG. 2. While within the coverage area of the gateway, an access device may authenticate itself to the gateway 118, and may share identification information with the gateway 118. It may also share information regarding parameters indicating the types or classifications of multimedia information that are of interest to the user of the access device. In addition, the access device may register, with the gateway 118, descriptive information about the multimedia information that access device has elected to share via the gateway 118. The descriptive information about the multimedia information on the access device may be registered with the gateway by adding it to a collection of all multimedia information known to the gateway such as, for example, the database 152 of FIG. 3. The parameters indicating types or classifications of interest to the access device user, and the information describing the multimedia information that may be present on the access devices (e.g., database 152) may be used by the gateway 118 to selectively advertise available multimedia information and media-related services to the user. As described above, a user of an access device such as, for example, access device 124, wireless PDA 119, and laptop 107 of FIG. 2 may be presented with such advertisements using, for example, pop-up graphics or text, graphical icons, or text messages.

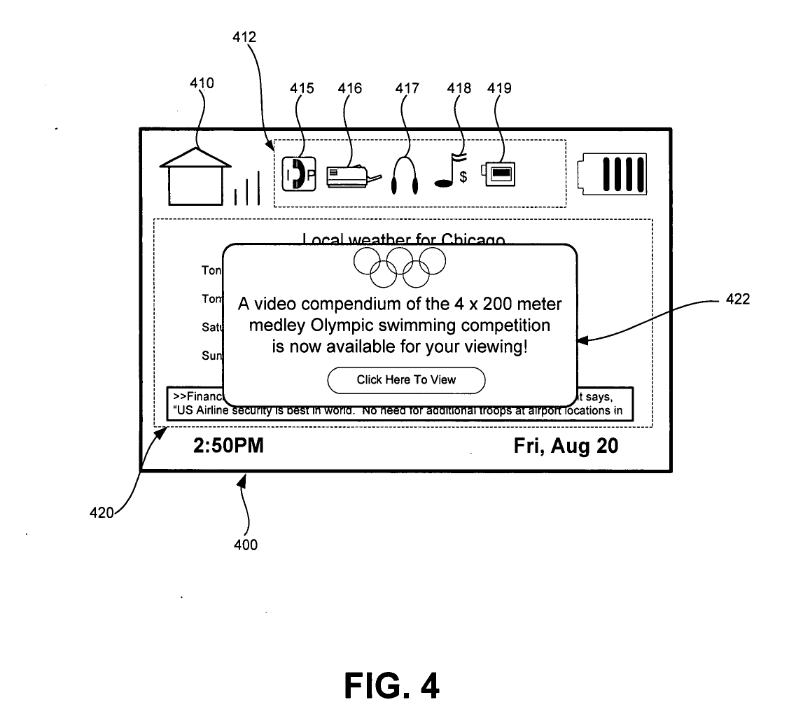

FIG. 4 illustrates an exemplary display 400 of an access device that may, for example, correspond to the display of the access device 124, the laptop 107, and the wireless PDA 119 of FIG. 2, showing a pop-up advertisement 422, in accordance with a representative embodiment of the present invention. The display 400 of FIG. 4 comprises a network indicator 410, a network services indicator area 412, a battery life indicator, a time of day indicator, and a day and date indicator. In addition, in the example of FIG. 4, the network services indicator area 412 has been updated to comprise an Internet protocol (IP) phone service icon 415, a printer service icon 416, a stereo entertainment icon 417, a pay music service icon 418, and a video entertainment icon 419, showing those services advertised by the wireless broadband access gateway as being available to an appropriately identified or authorized user of the access device. The display 400 also comprises a display area 420 to allow an access device to present graphical or textual information for a variety of reasons and from a number of sources. Upon arriving within the coverage area of a wireless broadband access gateway such as, for example, the gateway 118 as described with respect to FIG. 3, above, an access device in accordance with a representative embodiment of the present invention may exchange information that identifies the access device to the gateway. Using information received from the access device, the gateway 118 may select advertisements for distribution to the user of the access device. The display 400 of the access device of FIG. 4 illustrates an example of a pop-up advertisement 422 in accordance with a representative embodiment of the present invention. Other forms of presentation may be employed in various representative embodiments of the present invention such as, for example, graphical icons such as those in the network services indicator area 412, audible announcements, and video clips, to name only a few that have been contemplated.

In yet another representative embodiment in accordance with the present invention, access devices may be configured to seek out particular data (e.g., multimedia information) that may be of interest. Accordingly, an access device may be adapted to receive and process only those gateway advertisements that may fit particular criteria. Those advertisements that may not fit the particular criteria may be discarded or ignored. For example, a broadband access gateway such as, for example, gateway 118 or router 130 of FIG. 2 may advertise the availability of a multimedia file of, for example, travel-related information. The access device of the user may, however, be configured to ignore all advertising, or all advertising except for that related to, for example, multimedia information and/or services for rock concerts in the area in which the gateway 118 is located.

In a representative embodiment of the present invention, when an access device is within the range of a broadband access gateway such as, for example, the gateway 118 of FIG. 2, wireless service may be handed off from a serving cell site such as, for example, serving cell site 114a in the GSM network 114, to the gateway 118. The access device may be authenticated by the gateway 118 and may be permitted to access at least some of the multimedia information and services offered or accessible via the gateway 118. Once the access device is authenticated, a user of the access device may have a desire to locate a particular video presentation. The user may access a search engine provided by the gateway 118, which may have been advertised to the user's access device by the gateway 118. The search engine may appear on the display of the user's access device as an icon, for example.

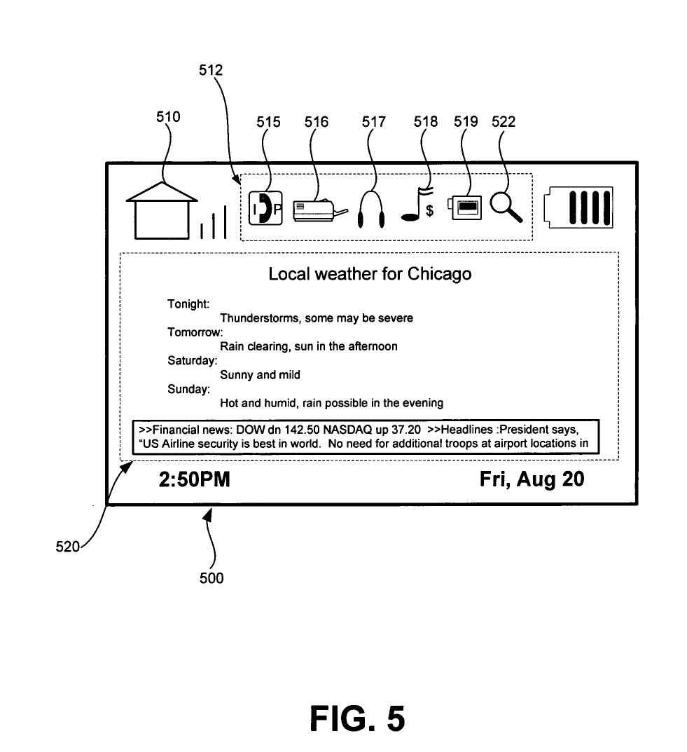

FIG. 5 illustrates an exemplary display 500 of an access device that may, for example, correspond to the display of the access device 124, the laptop 107, and the wireless PDA 119 of FIG. 2, in accordance with a representative embodiment of the present invention. The display 500 of FIG. 5 comprises a network indicator 510, a network services indicator area 512, a battery life indicator, a time of day indicator, and a day and date indicator. In addition, in the example of FIG. 5, the network services indicator area 512 has been updated to comprise an Internet protocol (IP) phone service icon 515, a printer service icon 516, a stereo entertainment icon 517, a pay music service icon 518, and a video entertainment icon 519, showing those services advertised by the wireless broadband access gateway as being available to an appropriately identified or authorized user of the access device. The display 500 also comprises a display area 520 to allow an access device to present graphical or textual information for a variety of reasons and from a number of sources. In addition to the group of icons described above, the network services indicator area 512 comprises a search engine icon 522. The search engine icon 522 may be used to indicate to a user of an access device, that a serving broadband access gateway such as, for example, the gateway 118 or router 130 of FIG. 2, supports user searches of available multimedia information and media-related services. When presented with the display 500, the user of the access device 124 may, for example, activate a search of the available multimedia information and services by selecting the search engine icon 522.

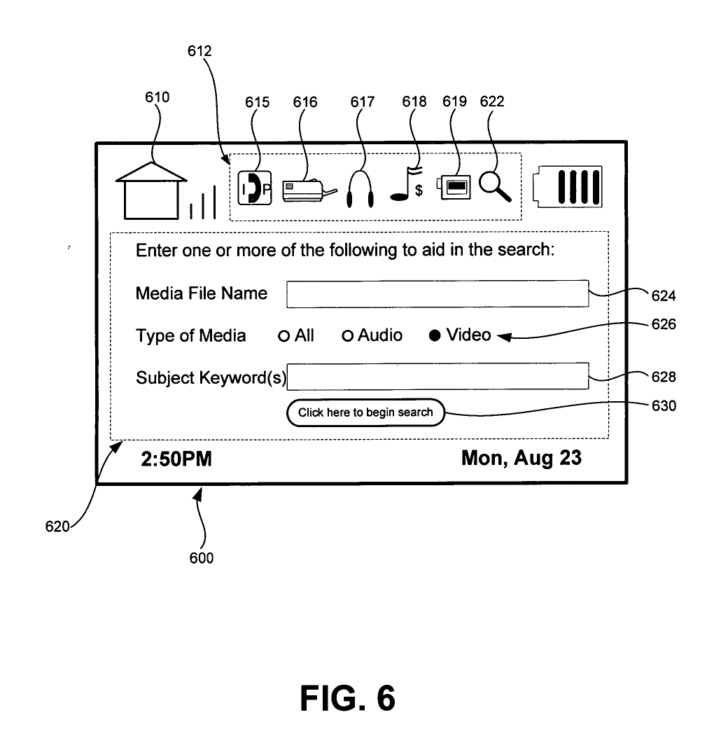

FIG. 6 illustrates an exemplary search parameters screen 600 that may be used to provide search parameters to a search engine of a broadband access gateway in accordance with a representative embodiment of the present invention. Similar to the display 500 of FIG. 5, the display 600 shown in FIG. 6 comprises a network indicator 610, a network services indicator area 612, a battery life indicator, a time of day indicator, and a day and date indicator. The example of FIG. 6 also comprises a network services indicator area 612 with an Internet protocol (IP) phone service icon 615, a printer service icon 616, a stereo entertainment icon 617, a pay music service icon 618, and a video entertainment icon 619 that may, for example, correspond to the icons of the same name in FIG. 5. The display 600 also comprises a display area 620, that in the illustration of FIG. 6 has been updated following user activation of the search functionality provided via the search engine icon 522 of FIG. 5. The display area 620 comprises a file name parameter box 624 to allow a user to specify part or all of a file name, if known, media type selection buttons 626 to indicate whether the user is interested in all types of media, only audio media, or only video media, and subject keyword(s) box 626, to allow the entry of applicable subject-descriptive words.

Once appropriate entries have been made using the file name parameter box 624, the media type selection buttons 626, and subject keyword(s) box 628, the user may commence the search by selecting the button 630 near the bottom edge of the display area 620. The broadband access gateway may then perform the search of the available multimedia information listed in the database 152 described above with respect to FIG. 3. Although the illustration of FIG. 6 includes the file name parameter box 624, the media type selection buttons 626, and subject keyword(s) box 628 as parameters to the search, a representative embodiment of the present invention is not limited to the particular parameters shown. A representative embodiment of the present invention may have a lesser or greater number of parameters, and may employ a variety of selection mechanisms without departing from the spirit or scope of the present invention. For example, the parameters used for the search may include information identifying the location or source of the multimedia information, the genre, the bandwidth or bit rate, the resolution, the size, the artist or author, the names of performers, and many other aspects of multimedia information. The information identifying the location or source of the multimedia information may comprise, for example, an identifier of an access device, a user identifier, a member identifier, an electronic serial number, a media access control (MAC) address, and an administrative identifier.

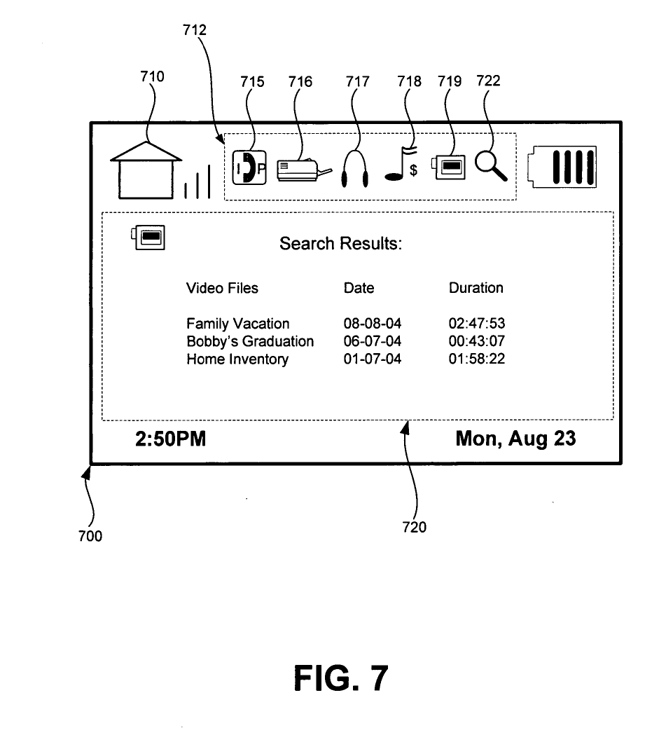

FIG. 7 illustrates an exemplary display 700 showing a listing of the results of a search using the search engine functionality provided via the search engine icon 522 of FIG. 5, using the search parameters shown in FIG. 6, in accordance with a representative embodiment of the present invention. In one representative embodiment of the present invention, if the search identifies a single matching reference, the multimedia information (in the example of FIG. 6, a video file) may begin to play/show the media file. If multiple media sources matching the search parameters are found, the user of the access device may be presented with a list, or an array of graphical objects, via the display of the access device. The user of the access device may then select the item that is to be shown/played.

In a representative embodiment of the present invention, a broadband access gateway such as, for example gateway 118 and router 130 of FIG. 2 may be adapted to classify information based on a given criterion. This classification may assist with locating information based on a particular criterion. For example, the gateway 118 may automatically examine the name of the file containing the multimedia information, and/or may examine the contents of multimedia file itself, to determine the nature of the information in the file. The gateway 118 may determine, for example, whether a multimedia file comprises digitized audio, video, text, calendar or phonebook information, or a file produced by any of a variety of commercial software applications. The gateway 118 may, for example, determine whether a pre-defined sequence of data appears, and may examine metadata about the file such as, for example, a file type, size, date of creation, etc. Using the results of such examinations and determinations, the broadband access gateway in one representative embodiment of the present invention may assign one of a pre-defined set of classifications to the information, based upon a pre-defined set of criteria. In another representative embodiment in accordance with the present invention, a user may be permitted to define, for example, the possible classifications and the associated criteria used in the classification process. In this manner, a user of an access device may be presented with a list of classifications from which to select, that may be of interest based on a particular criterion. This aspect of an embodiment of the present invention permits a user to narrow the focus of a search, simplifying access to the rapidly growing universe of multimedia information and services.

In various representative embodiments of the present invention, a broadband access gateway such as, for example, the gateway 118 or the router 130 of FIG. 2 may also be utilized to facilitate seamless synchronization of data between access devices such as, for example, the access device 124 or the laptop 117, that may be coupled in a wired or wireless fashion to the gateway 118. For example, audio files located on a PC such as, for example, the laptop 117 coupled to the gateway 118 may be synchronized with a wireless media player contained within a wireless PDA such as, for example, the wireless PDA 134. The wireless PDA 134 may, for example, be coupled to a hot spot in an airport, while a user of the wireless PDA 134 waits to board a flight. In this regard, a broadband access gateway in accordance with the present invention may determine what files are to be synchronized and may control how the synchronization is accomplished. The same may be true for files that may be downloaded from, for example, the laptop 117 to the wireless PDA 134, and for files that may be uploaded from, for example, the wireless PDA 134 to the laptop PC 117. Calendar and/or contact information may also be updated and/or synchronized with a PDA or other access device in a similar manner utilizing the gateway 118. In another representative embodiment of the present invention, multimedia information on an access device such as, for example, digital video files on the digital video camera 121 of FIG. 2, may be automatically synchronized with the laptop 117 of FIG. 2 by the gateway 118, upon the digital video camera 121 entering the coverage area of the gateway 118. The laptop 117 may, for example, automatically receive newly captured video media files, and the digital video camera 121 may receive edited video media files produced using the laptop 117. In yet another representative embodiment of the present invention, the gateway 118 may coordinate the synchronization of phonebook information on the wireless PDA 117 and the access device 124.

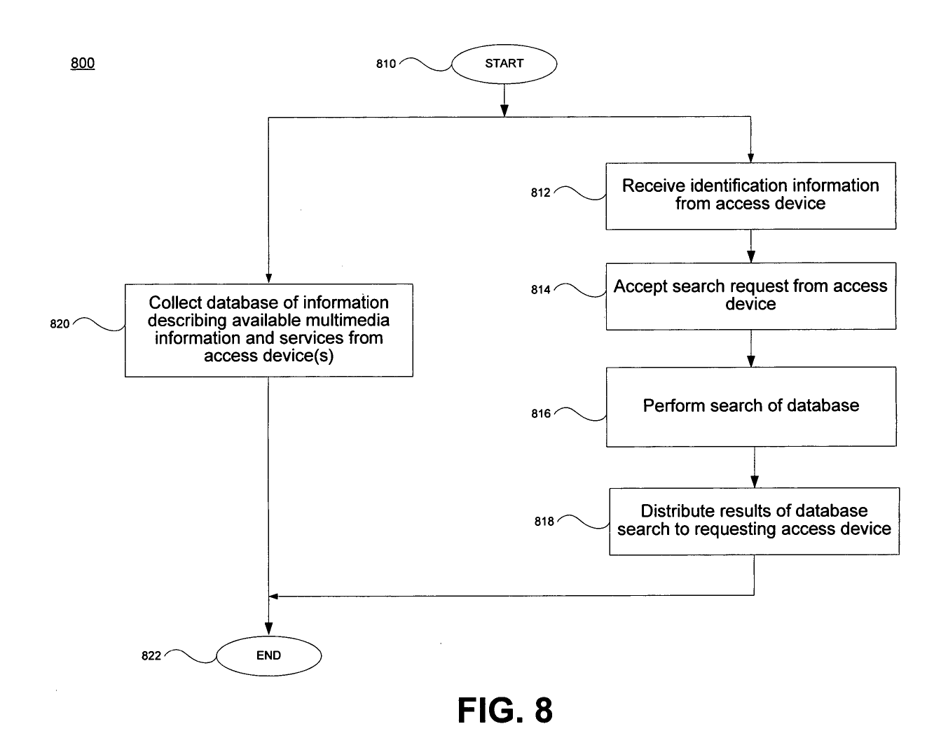

FIG. 8 is a flowchart for an exemplary method of supporting access to multimedia information and media-related services via a broadband access gateway such as, for example, the gateway 118 of FIGS. 2 and 3, using a location-based database and search engine, in accordance with a representative embodiment of the present invention. The following discussion of FIG. 8 makes reference to the elements of FIG. 2, although a representative embodiment of the present invention is not limited only to the particular elements shown or described with respect to FIG. 2. The flowchart of FIG. 8 comprises a left and right path, that may operate in parallel. The method illustrated in FIG. 8 begins when a broadband access gateway such as, for example, the gateway 118 is powered up (block 810). In the left path, a broadband access gateway such as, for example, gateway 118 collects a database of information describing the multimedia information that is available from the access device(s) that are in communication with the gateway 118 (block 820). Such access devices may include, for example, the access device 124 and the laptop 117 for gateway 118, and the wireless PDA 134, the laptop 136, and the PC 138 for router 130. For example, as new access devices enter and leave the coverage area of gateway 118, the database in gateway 118 may be updated to reflect descriptive information about the multimedia information currently available from the access device(s) within the coverage area of gateway 118. Although not shown in the illustration of FIG. 8, in another representative embodiment of the present invention, the broadband access gateway may also classify the sources of multimedia information that are found, using a set of criteria provided by the operator of the broadband access gateway, or by each of the users of the access devices using the broadband access gateway. As described above, the criteria used for classification may be associated with the user of the access device from which they are received, using identification information from the access device. By classifying the multimedia information sources available according to pre-defined criteria, a representative embodiment of the present invention provides simplified multimedia access for the user of the access device.

In the right path of the method illustrated in FIG. 8, a broadband access gateway may receive identification information from an access device (block 812). This may occur, for example, upon entry into the coverage area of the broadband access gateway, or periodically while the access device is in communication with a broadband access gateway such as, for example, the gateway 118 or the router 130. Although not shown in the illustration of FIG. 8, the gateway 118 may also receive, from the access device, information that describes what multimedia information, if any, is available for sharing by the access device. At some later point in time, the broadband access gateway may accept a search request from an access device (block 814). Using a set of parameters that may be provided in the search request, the broadband access gateway may perform a search of the database of information describing the available multimedia information (block 816). Following completion of the search, the broadband access gateway may distribute the result of the database search to the requesting access device (block 818). The method then ends (block 822) Although both the left and right paths of the method of FIG. 8 are shown as ending at block 822, in various representative embodiments the actions of the two paths may loop, continuing until the broadband access gateway is powered down.

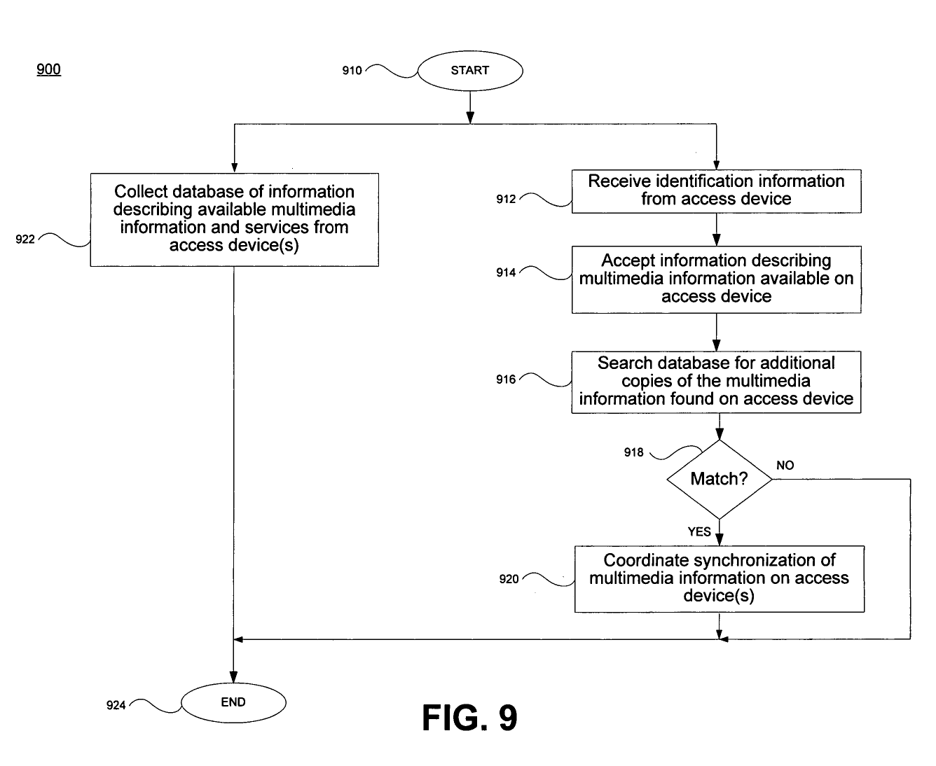

FIG. 9 is a flowchart for an exemplary method of supporting synchronization of multimedia information via a broadband access gateway such as, for example, the gateway 118 of FIGS. 2 and 3, using a location-based database and search engine, in accordance with a representative embodiment of the present invention. The following discussion of FIG. 9 makes reference to the elements of FIG. 2, although a representative embodiment of the present invention is not limited only to the particular elements shown or described with respect to FIG. 2. The flowchart shown in FIG. 9 comprises a left and a right path, that may operate in parallel. The method illustrated in FIG. 9 begins when a broadband access gateway such as, for example, the gateway 118 is powered up (block 910). In the left path, a broadband access gateway such as, for example, gateway 118 collects a database of information describing the multimedia information that is available from the access device(s) that are in communication with the gateway 118 (block 922). Such access devices may include, for example, the access device 124 and the laptop 117 for gateway 118, and the wireless PDA 134, the laptop 136, and the PC 138 for router 130. For example, as new access devices enter and leave the coverage area of gateway 118, the database in gateway 118 is updated to reflect descriptive information about the multimedia information currently available from access device(s) in the coverage area of gateway 118. Although not shown in the illustration of FIG. 9, in another representative embodiment of the present invention, the broadband access gateway may also classify the sources of multimedia information that are found, using a set of criteria provided by the operator of the broadband access gateway, or by each of the users of the access devices using the broadband access gateway. As described above, the criteria used for classification may be associated with the user of the access device from which they are received, using the identification information from the access device. Such classifications provide simplified access to the possibly large number of multimedia information sources available.

In the right path of the method illustrated in FIG. 9, a broadband access gateway may receive identification information from an access device (block 912). This may occur, for example, upon entry into the coverage area of the broadband access gateway, or periodically while the access device is in communication with a broadband access gateway such as, for example, the gateway 118 or the router 130 of FIG. 2. The gateway may also receive information describing the multimedia information that may be shared by the access device with other access devices (block 914). Using the information about multimedia information that may be available for sharing, the broadband access gateway may search the database, to determine whether any other access devices possess a copy of the same multimedia information (block 916). In another representative embodiment of the present invention, a search may not be performed, and information about the location of other copies that are to be kept in synchronism may be provided by users of access devices. If a match is found (block 918), the broadband access gateway may coordinate the synchronization of the multimedia information stored at the locations known to the gateway (block 920). Additional controls may determine how the synchronization is performed including, for example, whether a particular copy of the multimedia information is allowed to act only as the source, or if it may be updated from another access device. If a match is not found (block 918), no synchronization is performed. In either case, the method of FIG. 9 then ends (block 920). Although both the left and right paths of the method of FIG. 9 are shown as ending at block 924, in various representative embodiments the actions of the two paths may loop, continuing until the broadband access gateway is powered down.

Aspects of the present invention may be seen in a system supporting searching of information describing at least one of multimedia information and media-related services residing within a plurality of access devices. Such a system may comprise a gateway communicatively coupled to a broadband network and at least one wireless interface. The gateway may be capable of selectively exchanging multimedia information among the at least one wireless interface and the broadband network, and of communicating with the plurality of access devices via the at least one wireless interface. The gateway may be capable of collecting, from at least one of the plurality of access devices, information describing at least one of multimedia information and media-related services available on the at least one of the plurality of access devices. The gateway may also be capable of identifying a portion of the collected descriptive information using at least one parameter associated with at least one other of the plurality of access devices. In addition, the gateway may be capable of distributing to the at least one other of the plurality of access devices the identified portion of the collected descriptive information.

In various representative embodiments of the present invention, multimedia information may comprise at least one of streaming video, broadcast video, voice, digital data, text, digitized audio, digitized still images, digitized video, and digitized music. Media-related services may comprise at least one of accessing, recording, playing, exchanging, transmitting, receiving, converting, and translating of multimedia information. The at least one parameter may comprise information identifying a location of multimedia information, a genre, a bandwidth, a bit rate, a resolution, a size, a time, a date, an artist, an author, and a name of a performer. In a representative embodiment of the present invention, the at least one wireless interface may be compliant with the Bluetooth V1.2 or compatible personal area network (PAN) specification, may communicate using an unlicensed frequency band, and may communicate at a frequency of approximately 2.4 gigahertz. The at least one wireless interface may be compliant with at least one of the Institute of Electrical and Electronics Engineers (IEEE) 802.11a, 802.11b, 802.11g, and 802.11n standards. The broadband network may comprise at least one of a digital subscriber line (DSL) network, a cable network, a satellite network, a cellular network, and the Internet. The cellular network in a representative embodiment in accordance with the present invention may comprise at least one of a global system for mobile communications (GSM) network, a time division multiple access (TDMA) network, a code division multiple access (CDMA) network, and a universal mobile telecommunications system (UMTS) network. In various representative embodiments of the present invention, the information describing multimedia information may comprise at least one of a file name, a file type, a media type, a file size, a duration, a playback time, a member number, and an administrative ID. In various representative embodiments of the present invention, the information describing multimedia information may also comprise an electronic serial number, an Internet protocol (IP) address, a media access control (MAC) address, information identifying a make of an access device, and information identifying a model of an access device. In various representative embodiments of the present invention, the plurality of access devices may comprise at least one of a mobile multimedia handset, a personal digital assistant (PDA), a personal computer (PC), a digital scanner, a digital camera, a printer, headphones, and a pointing device.

In a representative embodiment in accordance with the present invention, the gateway may be capable of classifying the collected descriptive information, and of notifying the at least one other of the plurality of access devices of the availability of at least one of multimedia information and media related services. In addition, the gateway may be capable of synchronizing multimedia information across two or more access devices.

Additional aspects of the present invention may be seen in a method supporting the searching of information describing at least one of multimedia information and media-related services residing within a plurality of access devices. A method in accordance with the present invention may comprise collecting, via at least one of a wireless and a wired network, information describing at least one of multimedia information and media-related services available from at least one of the plurality of access devices. The method may also comprise identifying a portion of the collected descriptive information using at least one parameter associated with at least one other of the plurality of access devices. In addition, a method in accordance with the present invention may comprise distributing to the at least one other of the plurality of access devices the identified portion of the collected descriptive information. In various representative embodiments of the present invention, the at least one parameter may comprise information identifying a location of multimedia information, a genre, a bandwidth, a bit rate, a resolution, a size, a time, a date, an artist, an author, and a name of a performer. In various representative embodiments of the present invention, the information describing media-related services may comprise representations of at least one of accessing, recording, playing, exchanging, transmitting, receiving, converting, and translating of multimedia information. The wireless network may be compliant with the Bluetooth V1.2 or compatible personal area network (PAN) specification, may communicate using an unlicensed frequency band, and may communicate at a frequency of approximately 2.4 gigahertz. In addition, the wireless network may be compliant with at least one of the Institute of Electrical and Electronics Engineers (IEEE) 802.11a, 802.11b, 802.11g, and 802.11n standards. A representative embodiment of the present invention may further comprise exchanging, via at least one of the wireless and a broadband network, the at least one of multimedia information and media-related services. The broadband network may comprise at least one of a digital subscriber line (DSL) network, a cable network, a satellite network, a cellular network, and the Internet. The cellular network may comprise at least one of a global system for mobile communications (GSM) network, a time division multiple access (TDMA) network, a code division multiple access (CDMA) network, and a universal mobile telecommunications system (UMTS) network. The multimedia information may comprise at least one of streaming video, broadcast video, voice, digital data, text, digitized audio, digitized still images, digitized video, and digitized music. The plurality of access devices may comprise at least one of a mobile multimedia handset, a personal digital assistant (PDA), a personal computer (PC), a digital scanner, a digital camera, a printer, headphones, and a pointing device.

A method in accordance with an embodiment of the present invention may also comprise classifying the collected descriptive information. The method may comprise notifying the at least one other of the plurality of access devices of the availability of at least one of multimedia information and media related services, and the method may comprise synchronizing multimedia information across two or more access devices.

Yet other aspects of the present invention may be observed in a machine-readable storage, having stored thereon a computer program having a plurality of code sections executable by a machine, for causing the machine to perform the operations of the method described above.

In a representative embodiment of the present invention, the wireless local area networks may include data networks such as, for example, Institute of Electrical and Electronics Engineer (IEEE) 802.11a/b/g/n compliant wireless networks such as those located in homes, hot spots or an office. Such local area networks may operate in unlicensed radio frequency spectrum such as in, for example, the 2.4 and 5 gigahertz regions. Examples of wide area networks may include cellular digital packet data (CDPD), voice and data networks such as public switched telephone networks (PSTN), Global System For Mobile Communication (GSM), GSM General Packet Radio Service (GPRS), GSM Short Message Service (SMS), GSM Enhanced Data Rates For Global Evolution (EDGE), North American Time Division Multiplex Access (TDMA), iDEN, Code Division Multiple Access (CDMA) and CDMA2000 1xRT, Universal Mobile Telecommunications System (UMTS) network, to name only a few.

A personal area network (PAN) may be formed by a plurality of wireless communication access devices such as, for example, mobile multimedia handsets, PDAs, telephones, and computers. Other elements of such a network may, for example, include computer peripherals such as digital scanners, digital cameras, printers, headphones, and pointing devices, that may be located within the immediate proximity of a person. A PAN may be an ad-hoc network of such communication devices. In a representative embodiment of the present invention, access devices within the PAN may communicate with other access devices within the PAN and also with other access devices that are located in other networks accessible via the PAN. The personal area networks may include data networks such as, for example, a Bluetooth compliant network, and Institute of Electrical and Electronics Engineer (IEEE) 802.15.3a compliant wireless networks. Such personal area networks may operate in unlicensed radio frequency spectrum such as, for example, the 2.4 and 5 gigahertz regions. Details of one example of a personal area network are provided in the document “Bluetooth Core Specification V1.2”, Nov. 5, 2003, from Bluetooth SIG, Inc., the complete subject matter of which is hereby incorporated herein by reference, in its entirety. For example, in a Bluetooth® wireless PAN, a first Bluetooth®-enabled wireless access device may communicate with a second Bluetooth®-enabled wireless access device within the PAN. Additionally, either of the first and second Bluetooth®-enabled wireless access devices may communicate with the Internet or another LAN or WAN via the Bluetooth® wireless PAN.

In a representative embodiment of the present invention, a gateway may be adapted to provide seamless and transparent communication between a plurality of access devices and a plurality of networks. The functionality of the gateway may be divided, for example, into application content functionality, and configuration and management functionality. The application content functionality may, for example, deal with the types of applications that may be supported by the gateway as well as the various types of data that may be received, processed and/or transmitted by the gateway. In this regard, application content functionality may also include the manner in which other devices and/or systems may utilize data from the gateway.

Content and application services are important because all the information coming into and leaving the home from either the WAN side (i.e., the broadband connection side), or from the PAN side (i.e., the access device side) converges at the gateway. The PAN side may comprise Bluetooth, wireless LAN (IEEE 802.11 a/b/g/n), IEEE 802.15.3a ultra-wideband, or cellular, for example. Notwithstanding, the gateway may be adapted to convert, for example, wirelessly received GSM-formatted information into, for example, Internet protocol (IP)-formatted information and in reverse, converts IP-formatted information into wireless GSM-formatted information suitable for over-the-air transmission. Support for other wireless communication protocols such as TDMA, CDMA, and UMTS may also be provided. In a representative embodiment of the present invention, the gateway may comprise suitable circuitry, logic and/or code that may be adapted to receive and process MPEG related data, which may be suitable for display on a screen. The gateway in an embodiment of the present invention functions as a focal point where data converges from a plurality of wired and wireless services. Although, in a particular embodiment of the present invention the gateway may do very little in terms of actual content aggregation, there is virtual aggregation of data. The converged data may be integrated and or otherwise utilized to offer unique opportunities for launching various content and application services from a single strategic location. Since the gateway in an embodiment of the present invention is the focal point where data converges, one or more protocol stacks may be employed for launching the various content and application services.

The gateway in a representative embodiment of the present invention may be adapted to route calls based on established rules that may be programmed into the gateway. For example, the gateway may be governed by a rule which states that local calls are to be routed to an incumbent local exchange carrier (iLEC), while long distance calls are to be handled by Long Distance Carrier Company. Accordingly, when a call originates at the gateway and it is determined that the call is a local call, the gateway may be adapted to route the call to the iLEC. However, if the gateway determines that the call is a long distance call, then the gateway may be adapted to route the call to Long Distance Carrier Company.

A representative embodiment of the present invention may leverage existing broadband infrastructure that is commonly found in many homes and businesses today. Because a consumer is already paying for the use of the broadband infrastructure in their home or office, leveraging the use of the existing broadband infrastructure for communication with wide area networks results in minimal or no communication costs. The broadband infrastructure may be, for example, a cable or DSL infrastructure.

The wireless interface function provided by the gateway located within a home, for example, may be utilized to route or communicate a great deal of traffic to a wired network such as a broadband network or a wireless network such as a GSM or CDMA network via a broadband connection. In other words, the wireless gateway infrastructure provided by a representative embodiment of the present invention provides a scalable network infrastructure that rides on an existing access infrastructure already supplied by a broadband service provider to a home, office or business. Additionally, the scalable infrastructure provided by the gateway also solves the problems associated with signal penetration and propagation, thereby providing improved quality of service (QoS). From a market perspective, a wireless service provider may now have access to the necessary infrastructure to provide improved wireless services to users within a home or office. Accordingly, in order to rapidly increase their growth, wireless service providers may now target that portion of the in-home landline or plain old telephone system (POTS) business, which have traditionally been handled by incumbent local exchange carriers (ILECs) or other LECs.

The unlicensed mobile access gateway described above may possess a significant amount of processing power. The gateways of existing systems fall short of realizing the full potential of the merged wired and wireless communication network that is enabled by a representative embodiment of the present invention. Numerous basic and enhanced communication services may be enabled or provided by the gateway. Support for access devices such as, for example, mobile multimedia handsets and PDAs may be involved in order to utilize these basic and enhanced communication services enabled by the new wave of digital technologies. Current and/or proposed mobile access gateway systems, however, do not provide the range of support needed for their use by the everyday consumer.

The present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A system supporting searching of information describing at least one of multimedia information and media-related services residing within a plurality of access devices, the system comprising:
a gateway communicatively coupled to a broadband network and at least one wireless interface, the gateway capable of selectively exchanging multimedia information among the at least one wireless interface and the broadband network, and of communicating with the plurality of access devices via the at least one wireless interface;
the gateway capable of collecting, from at least one of the plurality of access devices, information describing at least one of multimedia information and media-related services available on the at least one of the plurality of access devices;
the gateway capable of identifying a portion of the collected descriptive information using at least one parameter associated with at least one other of the plurality of access devices; and
the gateway capable of distributing to the at least one other of the plurality of access devices the identified portion of the collected descriptive information.

2. The system according to claim 1 wherein multimedia information comprises at least one of streaming video, broadcast video, voice, digital data, text, digitized audio, digitized still images, digitized video, and digitized music.

3. The system according to claim 1 wherein media-related services comprise at least one of accessing, recording, playing, exchanging, transmitting, receiving, converting, and translating of multimedia information.

4. The system according to claim 1 wherein the at least one parameter comprises information identifying a location of multimedia information, a genre, a bandwidth, a bit rate, a resolution, a size, a time, a date, an artist, an author, and a name of a performer.

5. The system according to claim 1 wherein the at least one wireless interface is compliant with the Bluetooth V1.2 or compatible personal area network (PAN) specification.

6. The system according to claim 1 wherein the at least one wireless interface communicates using an unlicensed frequency band.

7. The system according to claim 1 wherein the at least one wireless interface communicates at a frequency of approximately 2.4 gigahertz.

8. The system according to claim 1 wherein the at least one wireless interface is compliant with at least one of the Institute of Electrical and Electronics Engineers (IEEE) 802.11a, 802.11b, 802.11g, and 802.11n standards.

9. The system according to claim 1 wherein the broadband network comprises at least one of a digital subscriber line (DSL) network, a cable network, a satellite network, a cellular network, and the Internet.

10. The system according to claim 9 wherein the cellular network comprises at least one of a global system for mobile communications (GSM) network, a time division multiple access (TDMA) network, a code division multiple access (CDMA) network, and a universal mobile telecommunications system (UMTS) network.

11. The system according to claim 1 wherein the information describing multimedia information comprises at least one of a file name, a file type, a media type, a file size, a duration, a playback time, a member number, an administrative ID, an electronic serial number, an Internet protocol (IP) address, a media access control (MAC) address, information identifying a make of an access device, and information identifying a model of an access device.

12. The system according to claim 1 wherein the plurality of access devices comprises at least one of a mobile multimedia handset, a personal digital assistant (PDA), a personal computer (PC), a digital scanner, a digital camera, a printer, headphones, and a pointing device.

13. The system according to claim 1, further comprising:
the gateway capable of classifying the collected descriptive information.

14. The system according to claim 1 further comprising:
the gateway capable of notifying the at least one other of the plurality of access devices of the availability of at least one of multimedia information and media related services.

15. The system according to claim 1 further comprising:
the system capable of synchronizing multimedia information across two or more access devices.

16. A method supporting the searching of information describing at least one of multimedia information and media-related services residing within a plurality of access devices, the method comprising:
collecting, via at least one of a wireless and a wired network, information describing at least one of multimedia information and media-related services available from at least one of the plurality of access devices;
identifying a portion of the collected descriptive information using at least one parameter associated with at least one other of the plurality of access devices; and
distributing to the at least one other of the plurality of access devices the identified portion of the collected descriptive information.

17. The method according to claim 16 wherein the at least one parameter comprises information identifying a location of multimedia information, a genre, a bandwidth, a bit rate, a resolution, a size, a time, a date, an artist, an author, and a name of a performer.

18. The method according to claim 16 wherein the information describing media-related services comprises representations of at least one of accessing, recording, playing, exchanging, transmitting, receiving, converting, and translating of multimedia information.

19. The method according to claim 16 wherein the wireless network is compliant with the Bluetooth V1.2 or compatible personal area network (PAN) specification.

20. The method according to claim 16 wherein the wireless network communicates using an unlicensed frequency band.

21. The method according to claim 16 wherein the wireless network communicates at a frequency of approximately 2.4 gigahertz.

22. The method according to claim 1 wherein the wireless network is compliant with at least one of the Institute of Electrical and Electronics Engineers (IEEE) 802.11a, 802.11b, 802.11g, and 802.11n standards.

23. The method according to claim 16 further comprising exchanging, via at least one of the wireless and a broadband network, the at least one of multimedia information and media-related services.

24. The method according to claim 23 wherein the broadband network comprises at least one of a digital subscriber line (DSL) network, a cable network, a satellite network, a cellular network, and the Internet.

25. The method according to claim 24 wherein the cellular network comprises at least one of a global system for mobile communications (GSM) network, a time division multiple access (TDMA) network, a code division multiple access (CDMA) network, and a universal mobile telecommunications system (UMTS) network.

26. The method according to claim 16 wherein the multimedia information comprises at least one of streaming video, broadcast video, voice, digital data, text, digitized audio, digitized still images, digitized video, and digitized music.

27. The method according to claim 16 wherein the plurality of access devices comprises at least one of a mobile multimedia handset, a personal digital assistant (PDA), a personal computer (PC), a digital scanner, a digital camera, a printer, headphones, and a pointing device.

28. The method according to claim 16 further comprising:
classifying the collected descriptive information.

29. The method according to claim 16 further comprising:
notifying the at least one other of the plurality of access devices of the availability of at least one of multimedia information and media related services.

30. The method according to claim 16 further comprising:
synchronizing multimedia information across two or more access devices.

31. A machine-readable storage, having stored thereon a computer program having a plurality of code sections for operating a gateway supporting the searching of information describing at least one of multimedia information and media-related services residing within a plurality of access devices, the code sections executable by a machine for causing the machine to perform the operations comprising:
collecting, via at least one of a wireless and a wired network, information describing at least one of multimedia information and media-related services available from at least one of the plurality of access devices;
identifying a portion of the collected descriptive information using at least one parameter associated with at least one other of the plurality of access devices; and
distributing to the at least one other of the plurality of access devices the identified portion of the collected descriptive information.

32. The machine-readable storage according to claim 31 wherein the at least one parameter comprises information identifying a location of multimedia information, a genre, a bandwidth, a bit rate, a resolution, a size, at time, a date, an artist, an author, and a name of a performer.

33. The machine-readable storage according to claim 31 wherein the information describing media-related services comprises representations of at least one of accessing, recording, playing, exchanging, transmitting, receiving, converting, and translating of multimedia information.

34. The machine-readable storage according to claim 31 wherein the wireless network is compliant with the Bluetooth V1.2 or compatible personal area network (PAN) specification.

35. The machine-readable storage according to claim 31 wherein the wireless network communicates using an unlicensed frequency band.

36. The machine-readable storage according to claim 31 wherein the wireless network communicates at a frequency of approximately 2.4 gigahertz.

37. The machine-readable storage according to claim 31 wherein the wireless network is compliant with at least one of the Institute of Electrical and Electronics Engineers (IEEE) 802.11a, 802.11b, 802.11g, and 802.11n standards.

38. The machine-readable storage according to claim 31 wherein the code sections executable by a machine further causing the machine to perform the operations comprising:
exchanging, via at least one of the wireless and a broadband network, the at least one of multimedia information and media-related services.

39. The machine-readable storage according to claim 38 wherein the broadband network comprises at least one of a digital subscriber line (DSL) network, a cable network, a satellite network, a cellular network, and the Internet.

40. The machine-readable storage according to claim 39 wherein the cellular network comprises at least one of a global system for mobile communications (GSM) network, a time division multiple access (TDMA) network, a code division multiple access (CDMA) network, and a universal mobile telecommunications system (UMTS) network.

41. The machine-readable storage according to claim 31 wherein the multimedia information comprises at least one of streaming video, broadcast video, voice, digital data, text, digitized audio, digitized still images, digitized video, and digitized music.

42. The machine-readable storage according to claim 29 wherein the plurality of access devices comprises at least one of a mobile multimedia handset, a personal digital assistant (PDA), a personal computer (PC), a digital scanner, a digital camera, a printer, headphones, and a pointing device.

43. The machine-readable storage according to claim 31 wherein the code sections executable by a machine further causing the machine to perform the operations comprising:
classifying the collected descriptive information.

44. The machine-readable storage according to claim 31 wherein the code sections executable by a machine further causing the machine to perform the operations comprising:
notifying the at least one other of the plurality of access devices of the availability of at least one of multimedia information and media related services.

45. The machine-readable storage according to claim 31 wherein the code sections executable by a machine further causing the machine to perform the operations comprising:
synchronizing multimedia information across two or more access devices.
